(19) United States
(12) Patent Application Publication
(10) Pub. No.: US 2023/0381052 A1
(43) Pub. Date: Nov. 30, 2023

(54) Walking Assistance System and Method for Controlling the Same

(71) Applicants: Hyundai Motor Company, Seoul (KR); Kia Corporation, Seoul (KR)

(72) Inventors: Ji Min Han, Anyang-si (KR); Jong Kyu Choi, Yongin-si (KR)

(21) Appl. No.: 17/986,657

(22) Filed: Nov. 14, 2022

(30) Foreign Application Priority Data
May 26, 2022 (KR) 10-2022-0064827

(51) Int. Cl. A61H 3/00; A61H 1/02; A61G 5/04; G05D 1/02; G06V 20/58

(52) U.S. Cl. CPC A61H 3/00; A61H 1/0262; A61G 5/04; G05D 1/0238; G05D 1/0212; G05D 1/0287; G06V 20/58; A61H 2201/5058; A61H 2201/5092; A61H 2201/1215; A61H 2201/5069; A61H 2201/1659; A61H 2201/164; A61H 2201/165

(57) ABSTRACT

A walking assistance system may be controlled by a method for controlling the same. The walking assistance system comprises an mobility device movable by a first driving part, a walking assistance robot, comprising one or more joint parts, and movable by a second driving part, and a controller that is configured to drive one or more of the first driving part or the second driving part so as to control the mobility device and the walking assistance robot to move in coordination with each other. The electric mobility device and the walking assistance robot may be moved to adjust a relative horizontal location between the mobility device and the walking assistance robot and to adjust a relative vertical location between the mobility device and the walking assistance robot, and controlling a total distance between the mobility device and the walking assistance robot to a reference distance.

### CROSS-REFERENCE TO RELATED APPLICATION

This application claims the benefit of priority to Korean Patent Application No. 10-2022-0064827, filed in the Korean Intellectual Property Office on May 26, 2022, the entire contents of which are incorporated herein by reference.

### TECHNICAL FIELD

The present disclosure relates to a walking assistance system and a method for controlling the same, and more particularly, to a technology of allowing a user to easily switch a mobility device and a walking assistance robot.

### BACKGROUND

The robots may be adapted to assist a user. For example, a mobility assistance robot, such as a walking assistance robot, and may enable and/or improve mobility of a user having limited mobility, such as in a case of a handicapped person and the aged. Walking assistance robots, for example, may become increasingly useful in societies with aging populations.

Currently, walking assistance robots are not widely commercially available, particularly not for everyday and/or personal use. A person in need of mobility assistance may therefore be separately provided with a walking assistance robot and a mobility device, such as an electric wheelchair. The walking assistance robot may be suitable for assisting in certain mobility behaviors (e.g., a limited set of circumstances), and the electric wheelchair may be suitable for other mobility behaviors (e.g., a complementary set of circumstances).

If the mobility device and the walking assistance robot are selectively used, the user may feel inconvenience when the user desires to use the walking assistance robot while using the mobility device or desires to use the mobility device while using the walking assistance robot. Accordingly, a measure for reducing inconvenience of the user is required.

### SUMMARY

The following summary presents a simplified summary of certain features. The summary is not an extensive overview and is not intended to identify key or critical elements.

Systems, apparatuses and methods are described for controlling a mobility assistance system. A mobility assistance system may comprise a mobility device (e.g., an electric wheelchair) and a mobility assistance robot (e.g., a walking assistance robot). The mobility system may be controlled by a controller, which may cause, by controlling at least one of a first drive of a mobility device or a second drive of a mobility assistance robot, the mobility device and the mobility assistance robot to be in a predefined relative orientation with each other, the mobility device and the mobility assistance robot to be in a predefined spatial alignment with each other, and/or the mobility device and the mobility assistance robot to be within a preset reference distance from each other.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIGS. 1 and 2 are views of a walking assistance system according to an example of the present disclosure;

FIG. 3 is a block diagram for a walking assistance system according to an example of the present disclosure;

FIG. 4 is a flowchart for a method for controlling a walking assistance system according to an example of the present disclosure;

FIG. 5 shows an example of adjusting a horizontal location of a mobility device and a walking assistance robot;

FIGS. 6A, 6B, and 6C show an example of a locational relationship of a mobility device and a walking assistance robot when they are in a parallel state (FIG. 6B), and examples when they are not (FIGS. 6A and 6C);

FIGS. 7A, 7B, and 7C show an example of image frames acquired by a mobility device;

FIG. 8 shows an example of a target image frame;

FIGS. 9A, 9B, and 9C show an example of adjusting a distance between a mobility device and a walking assistance robot;

FIG. 10 shows an example of obstacle detection;

FIG. 11, FIG. 12, and FIG. 13 show an example of obstacle avoidance;

FIG. 14 shows a flowchart for a method of controlling a walking assistance system according to an example of the present disclosure; and

FIG. 15 shows a flowchart for a method for evaluating reliability according to an example of the present disclosure.

### DETAILED DESCRIPTION

Hereinafter, some examples of the present disclosure will be described in detail with reference to the exemplary drawings. Throughout the specification, the same reference numerals denote the same components, even if referring to different drawings. A detailed description of known functions and configurations incorporated herein will be omitted when it may make the subject matter of the present disclosure unnecessarily complicated.

Terms, such as first, second, etc.; A, B, etc.; (a), (b), etc.; or the like may be used herein when describing components of the present disclosure. Such terms are provided only to distinguish the components from other components, and the essences, sequences, orders, and the like of the components are not limited by an alphabetic and/or numerical order of such terms. In addition, unless defined otherwise, all terms used herein, including technical or scientific terms, have the same meanings as those generally understood by those skilled in the art to which the present disclosure pertains. Terms defined in general use dictionaries should be construed as having meanings consistent with the contexts of the relevant technological subject matter. Terms should not be construed as having ideal or excessively formal meanings unless clearly defined in the specification of the present disclosure.

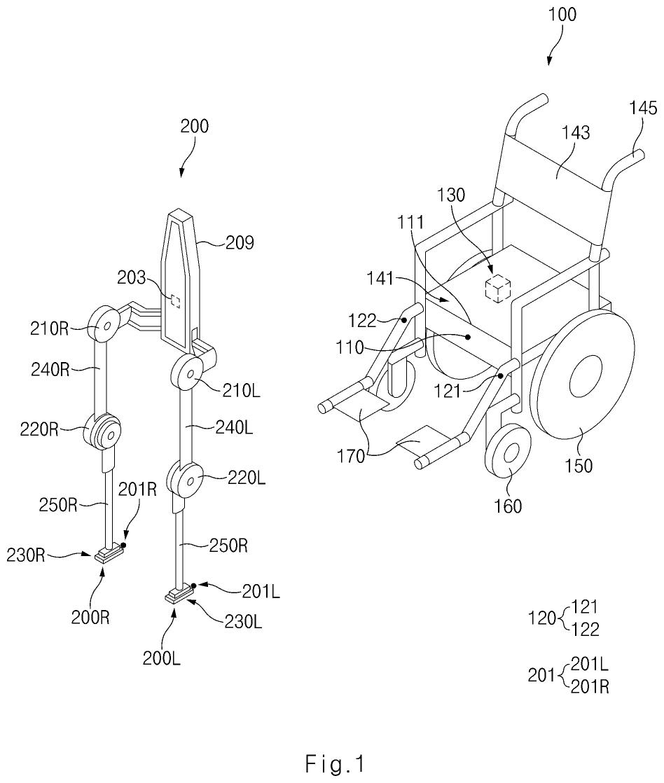

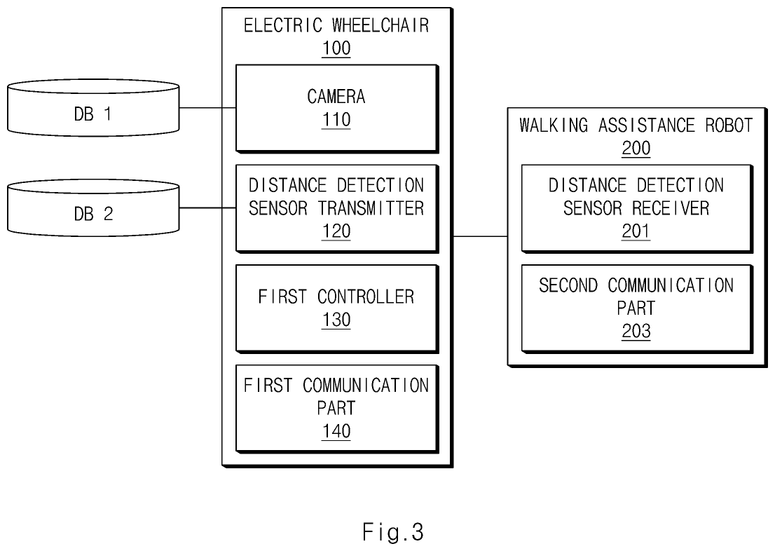

Referring to FIGS. 1 to 3, a walking assistance system may comprise a mobility device (e.g., a wheelchair) 100 and a walking assistance robot 200.

The mobility device 100 may comprise a camera 110, a distance detection sensor transmitter 120, a controller 130, and a first communication part 140.

The camera 110 may be adapted to acquire an image from the mobility device 100, and may be located towards a front of a seat 141, where the front is a side and/or direction that the seat 141 is configured to have a user sit when using the mobility device 100. The camera 110 may be located elsewhere on the mobility device 100 and/or separate from the mobility device, so long as it is able to function as described herein (e.g., acquire an image as discussed in the following).

The mobility device 100 may comprise one or more mobility components, (e.g., wheels, treads, legs, etc.) capable of moving the mobility device 100 and/or a user of the mobility device over a distance (e.g., over a distance over a surface, such as a floor or ground). The mobility components may be drivable by the first driving part. In the following, wheels 150 will be discussed as an example mobility component for the sake of providing a clear example. Wheels 150 may be configured to be caused to rotate by a first driving part. The wheels 150 may be disposed on one or more locations on the mobility device, such as on opposite sides of the seat 141, so as to allow room for a user to sit, and so as to balance and support the seat 141. Auxiliary wheels 160 (and/or auxiliary mobility components) may also be disposed on the mobility device 100. The auxiliary wheels 160 may be capable of rotating as the wheels 150 are rotated. Handles 145 may be provided for manually manipulating the mobility device 100. The handles 145 may be formed towards a top and/or back of the seat 141, so as to allow for a second user to push, pull, and/or direct the mobility device 100. A back support 143 may be formed between the handles 145.

The distance detection sensor transmitter 120 may be configured to transmit a signal, and may be configured to acquire a detected distance from a distance detection sensor receiver 201 located in the walking assistance robot 200. The distance detection sensor transmitter 120 may comprise a first distance detection transmitter 121 and a second distance detection transmitter 122. The first distance detection transmitter 121 may be configured to acquire a first detection distance from a first distance detection receiver 201L, and the second distance detection transmitter 122 may be configured to acquire a second detection distance from a second distance detection receiver 201R.

The controller 130 may be configured to perform a control such that the mobility device 100 and the walking assistance robot 200 move in coordination with each other (e.g., follow each other, move to achieve and/or maintain one or more relative spatial arrangements with each other). For example, the controller may be and/or comprise a computing device comprising one or more processors and a memory storing one or more non-transitory computer readable instructions that, when executed, may cause the controller 130 to function and/or perform the actions described herein. The controller 130 may be configure to control (e.g., by executing the one or more non-transitory computer readable instructions) one or more of the first driving part of the mobility device 100 or the second driving part of the walking assistance robot 200. The first driving part may comprise one or more motor(s), and/or any other motion controller(s) for providing motion to, and/or changing motion of, the mobility device 100. for example. The second driving part may comprise one or more motor(s), and/or any other motion controller(s) for providing motion to, and/or changing motion of, the walking assistance robot 200. For example, the second driving part may comprise hip joint driving parts 210L and 210R and knee driving parts 220L and 220R.

The controller 130 may be configured to control any one of the walking assistance robot 200 and/or the mobility device 100 so as to cause the walking assistance robot 200 and/or the mobility device 100 into relative positions that correspond to a user switching configuration. A user switching configuration may refer to a configuration in which if a user were wearing the walking assistance robot 200, they would be capable of mounting (e.g., becoming seated on) the mobility device 100, and/or if a user were mounted on the mobility device 100, they would be capable of mounting (e.g., wearing) the walking assistance robot 200. The user switching configuration may refer to a configuration of the mobility device 100 and the walking assistance robot 200 relative to each other that would enable a user of one thereof to conveniently (e.g., without or with minimal external assistance, and/or without being substantially unsupported) switch to the other.

To achieve the user switching configuration, the controller 130 may adjust a relative horizontal location between the mobility device 100 and the walking assistance robot 200. Horizontal, in this disclosure, may refer to one or more directions substantially parallel with a portion of a surface over which the mobility device 100 and/or the walking assistance robot 200 may be configured to mover over. For example, a horizontal direction may be a direction substantially parallel to a portion of a floor that the mobility device is configured to travel over. A relative horizontal location between the mobility device 100 and the walking assistance robot 200 may refer distance and direction between a location on a surface of the mobility device 100 and a location on the surface of the walking assistance root 200. The relative horizontal location between the mobility device 100 and the walking assistance robot 200 may be adjusted by adjusting one or more of their locations such that a first reference line RL1 and a second reference line RL2 become parallel to each other. Reference lines referred to herein may be hypothetical lines used to indicate, discuss and/or describe a spatial relationship between and/or orientation, and/or movement of one or more components; reference lines do not necessarily refer to any physical structure or object constituting the lines. The first reference line RL1 may be a line in a horizontal direction and approximately normal to a front direction of the mobility device 100. A front direction of the mobility device 100 may correspond to a direction in which a user would be configured to face when using the mobility device 100. The first reference line RL1 may be a line that connects the first distance detection transmitter 121 and the second distance detection transmitter 122. The first distance detection transmitter 121 may be installed on one side of the mobility device 100 and the second distance detection transmitter 122 may be installed on another side of the mobility device 100. The first distance detection transmitter 121 may be installed on a side support that connects the seat 141 and a foot plate 170 The second distance detection transmitter 122 may be installed on an opposite side support that connects the seat 141 and another foot plate 170.

To achieve the user switching configuration, the controller 130 may also, or alternatively, cause adjusting of a relative vertical location between the mobility device 100 and the walking assistance robot 200. Adjusting of a relative vertical location between the mobility device 100 and the walking assistance robot 200 may comprise adjusting a location of a reference point of the mobility device 100 relative to a reference point of the walking assistance robot 200. The reference points may be selected to be corresponding points based on a symmetry of the mobility device 100 and/or a symmetry of the walking assistance robot 200 and/or corresponding points indicative of an intended location of a user or part thereof, such as a location where a left foot of a user may be during use of the mobility device 100 and/or a location where a left foot of a user may be during use of the walking assistance robot 200. The reference point of the mobility device 100 may be a first center C1 of the mobility device 100. The reference point of the walking assistance robot 200 may be a second center C2 of the walking assistance robot 200. The adjusting the relative vertical location may comprise adjusting a location of the first center C1 and/or a location of the second center C2 such that a line that connects the first center C1 and the second center C2 is perpendicular to the first reference line RL1 and the second reference line RL2. The first center C1 of the mobility device 100 may be a center point between the first distance detection transmitter 121 and the second distance detection transmitter 122. The second center C2 of the walking assistance robot 200 may be a center point between the first distance detection receiver 201L and the second distance detection receiver 201R.

The controller 130 may be configured to use an image frame acquired by the camera 110 to adjust the relative vertical location between the mobility device 100 and the walking assistance robot 200. The controller 130 may perform object recognition on the image frame (e.g., using artificial intelligence). The controller 130 may determine a location of the walking assistance robot 200 based on the object recognition. The controller 130 may comprise an artificial intelligence (hereinafter, referred to as AI) processor. The AI processor may be configured to learn a neural network by executing the non-transitory computer readable instructions. A neural network for performing object recognition in an image may be configured to simulate an object recognition function of a brain of a person on a computer. The neural network may comprise a plurality of network nodes, having weights, that simulate neurons of a neural network of a person. The plurality of network nodes may send and receive data according to their connection relationships to simulate synaptic activities of neurons that send and receive signals through synapses. The neural network may comprise a deep learning model developed from a neural network model. In the deep learning model, the plurality of network nodes may be located on different layers and may send and receive data according to a convolution connection relationship. Examples of the neural network model may be based on various deep learning techniques, and may comprise deep neural networks (DNNs), convolutional deep neural networks (CNNs), a recurrent Boltzmann machine (RNN), a restricted Boltzmann machine (RBM), deep belief networks (DBNs), and/or a deep Q-network.

The controller 130 may control a distance between the mobility device 100 and the walking assistance robot 200 to a preset reference distance Rd. Furthermore, the switching configuration may correspond to a configuration in which the mobility device 100 and the walking assistance robot 200 are spaced apart from each other by the reference distance Rd. The reference distance Rd may be set in advance, and/or may be varied and/or selected according to a size of the user.

The first communication part 140 may be configured to communicate with a second communication part 203, and/or to transmit a control signal generated by the controller 130 to the walking assistance robot 200.

The walking assistance robot 200 may comprise a body part 209 configured to support a back of a wearer, and leg parts 200R and 200L configured to extend from the body part 209 to be connected to each other.

The leg parts 200R and 200L may comprise hip joint driving parts 210L and 210R, which may extend from opposite sides of the body part 209; thigh links 240L and 240R, first ends of which may be connected to the hip joint driving parts 210L and 210R, respectively; knee driving parts 220L and 220R, which may be connected to second ends of the thigh links 240L and 240R (e.g., ends opposite of the first ends); calf links 250L and 250R, first ends of which may be connected to the knee driving parts 220L and 220R, respectively; and/or ground surface support parts 230L and 230R, which may be fixed to second ends of the calf links 250L and 250R (e.g., ends opposite of the first ends).

An interior space may be formed in the body part 209. One or more components for controlling the walking assistance robot 200 may be disposed in the interior space, for convenience and efficient space use. For example, a controller for controlling of the walking assistance robot 200, a driving IC for driving driving parts of the joints (e.g., joints 210R, 210L, 220R, 220L), an inertia sensor for detecting an inclination (e.g., a pitch) of the body part 209 itself, and/or a battery for providing electric power to various components that constitute the robot.

The leg parts 200L and 200R may be fastenable to legs of a user. The leg parts 200L and 200R may be configured to be fastenable to the legs of a user such that, when the user is standing on a ground surface, the leg parts 200L and 200R may be situated between the body part 209 and the ground surface. The leg parts 200L and 200R may be configured to assist walking of the wearer by operation of the driving parts disposed at joints of the leg parts 200L and 200R.

The leg parts 200R and 200L may comprise the hip joint driving parts 210L and 210R, which may extend from opposite sides of the body part 209; the thigh links 240L and 240R, ends of which may be connected to the hip joint driving parts 210L and/or 210R, respectively; the knee driving parts 220L and/or 220R, which may be connected to opposite ends of the thigh links 240L and/or 240R; the calf links 250L and 250R, ends of which may be connected to the knee driving parts 220L and 220R, respectively; and/or the ground surface support parts 230L and 230R, which may be fixed to opposite ends of the calf links 250L and 250R.

The hip joint driving parts 210L and 210R and/or the knee driving parts 220L and 220R may be configured to be driven under control of the controller (e.g., capable of receiving and/or responding to signals from the controller. For example, the hip joint driving parts 210L and/or 210R, and/or the knee driving parts 220L and/or 220R may comprise a motor configured to convert electric energy to a kinetic energy, such as rotational energy capable of generating a rotational force, an actuator, and/or the like. An encoder for detecting a rotational angle may be comprised in one or more of the hip joint driving parts 210L or 210R or the knee driving parts 220L or 220R. The controller 130 may be configured to receive feedbacks based on the rotational angles detected by the encoders to control the hip joint driving parts 210L and/or 210R and/or the knee driving parts 220L and/or 220R.

The thigh links 240L and/or 240R and/or the calf links 250L and/or 250R may be connected to one or more of the hip joint driving parts 210L and 210R and/or the knee driving parts 220L and 220R. The thigh link 240L may be connected to and rotatable relative to the calf link 240L via the hip joint driving part 210L, and the thigh link 240R may be connected to and rotatable relative to the calf link 240R via the hip joint driving part 210R. The thigh links 240L and/or 240R and/or the calf links 250L and/or 250R may comprise fastening units (e.g., harnesses, belts, buttons, etc.) to fasten to the legs of the wearer.

The ground surface support parts 230L and/or 230R may be attached to distal ends of the calf links 250L and 250R, relative to the body 209, for example. Distal ends of the calf links 250L and 250R may be directly fixed to the ground surface support parts 230L and 230R, e.g., without use of an element constituting a separate joint

The walking assistance robot 200 may comprise the distance detection sensor receiver 201 and/or the second communication part 203. The distance detection sensor receiver 201 may comprise the first distance detection receiver 201L and the second distance detection receiver 201R.

The second communication part 203 may be configured to communicate with the first communication part 140, and/or may be configured to receive a control signal generated by the controller 130.

A first database DB1 may be configured to receive and/or store image data acquired by the camera 110. A second database DB2 may be configured to receive and/or store detection distance information acquired through the distance detection sensor transmitter 120 and/or the distance detection sensor receiver 201. The first and/or second databases DB1 and/or DB2 may be provided in the mobility device 100 or the walking assistance robot 200, and/or may be provided in a separate server. The first and/or second databases DB1 and/or DB2 may be constituted by one or more nonvolatile memories, such as a hard disk drive, a flash memory, an electrically erasable programmable read-only memory (EEPROM), a static RAM (SRAM), a ferro-electric RAM (FRAM), a phase-change RAM (PRAM), and a magnetic RAM (MRAM), and volatile memories, such as a dynamic random access memory (DRAM), a synchronous dynamic random access memory (SDRAM), a double date rate-SDRAM (DDR-SDRAM).

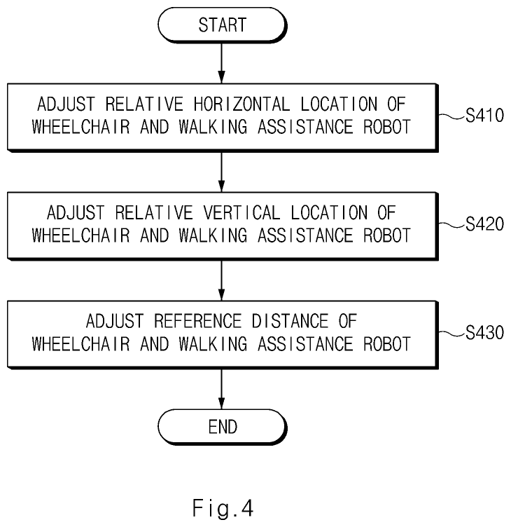

Hereinafter, a method for controlling a walking assistance system according to an example of the present disclosure will be described in detail with reference to FIG. 4. FIG. 4 is a flowchart illustrating the method for controlling a walking assistance system according to the present disclosure.

In S410, the controller 130 may adjust the relative horizontal location between the mobility device 100 and the walking assistance robot 200.

Referring to FIG. 5, the relative horizontal location between the mobility device 100 and the walking assistance robot 200 may be adjusted such that the first reference line RL1 and the second reference line RL2 become parallel to each other.

The first reference line RL1 may be a straight line in a horizontal direction, as discussed previously. For example, the first reference line RL1 may be parallel to a front direction (e.g., a front facing surface) of the mobility device 100. A front direction of the mobility device 100 may correspond to a direction in which the mobility device 100 is configured to be entered and/or exited by a user and/or a direction in which the mobility device 100 is configured to have a user face while using the mobility device 100 (e.g., while traveling and/or sitting in the mobility device 100). Also, or alternatively, the first reference line RL1 may be a straight line that connects the first distance detection transmitter 121 and/or a second distance detection transmitter 122.

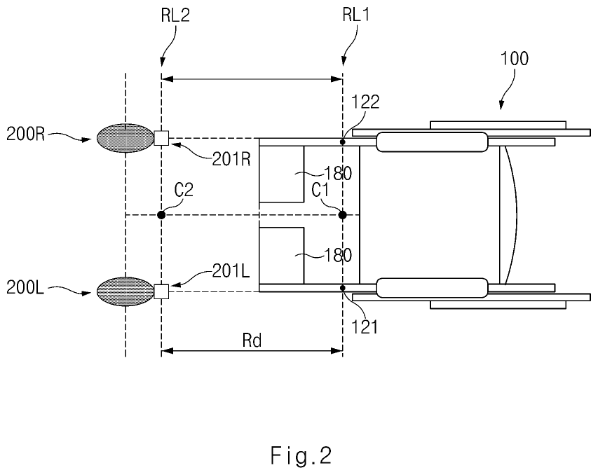

The second reference line RL2 may be a straight line that may connect the ground surface support parts 230L and 230R of the walking assistance robot 200 (e.g., corresponding points, such as on a front edge, of the ground surface support parts 230L and 230R). The second reference line RL2 may be defined for the walking assistance robot 200 in a state in which the opposite ground surface support parts 230L and 230R are parallel to each other (e.g., configured such that if a user were to wear the walking assistance robot 200, the user's legs would be oriented in a same direction). The second reference line RL2 may be a line that connects the first and second distance detection transmitters 201L and 201R coupled to the opposite ground surface support parts 230L and 230R. Hereinafter, in the specification, the opposite ground surface support parts 230L and 230R viewed from a top will also, or alternatively, be referred to as, and will be used to referred to, the walking assistance robot 200 (e.g., as in FIG. 2).

To adjust the locations of the mobility device 100 and the walking assistance robot, the controller 130 may acquire a first detection distance d1 and a second detection distance d2. The first detection distance d1 may be a distance between the first distance detection transmitter 121 and the first distance detection receiver 201L. The second detection distance d2 may be a distance between the second distance detection transmitter 122 and the second distance detection receiver 201R. As shown in in FIG. 5, when the first detection distance d1 and the second detection distance d2 are different, the first reference line RL1 and the second reference line RL2 may not parallel to each other. The controller 130 may determine that reference line RL1 is not parallel to reference line RL2 based on the first detection distance d1 being different from the first detection distance d2, and vice versa.

The controller 130 may cause movement of the mobility device 100 and/or the walking assistance robot 200 such that the first reference line RL1 and the second reference line RL2 become parallel to each other, in a case that they are first determined to not be parallel to each other. The controller 130 may cause rotation of the first reference line RL1 by causing rotation of one or more wheels of the mobility device 100. A rotation degree thereof may be determined such that the first detection distance d1 and the second detection distance d2 become the same, and may be proportional to a deviation between the first detection distance d1 and the second detection distance d2.

In S420, the controller 130 may cause adjustment of the relative vertical location between the mobility device 100 and the walking assistance robot 200. Adjusting of the vertical locations of the mobility device 100 and/or the walking assistance robot 200 may comprise an operation to arranging the first center C1 of the mobility device 100 and/or the second center C2 of the walking assistance robot 200. The first center C1 of the mobility device 100 may refer to the center point between the first distance detection transmitter 121 and the second distance detection transmitter 122. The second center C2 of the walking assistance robot 200 may refer to a center point between the first distance detection receiver 201L and the second distance detection receiver 201R.

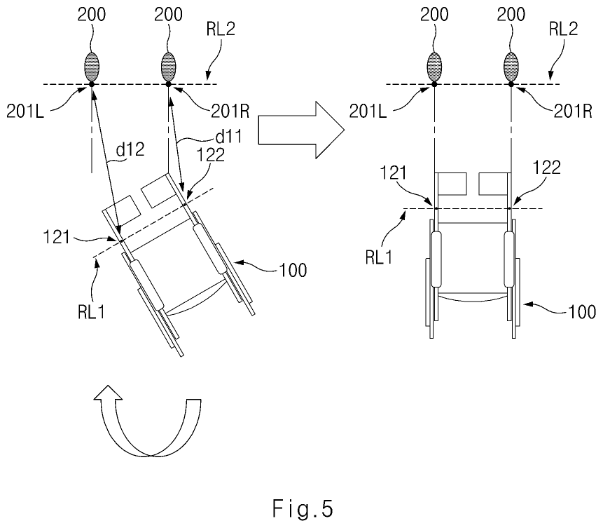

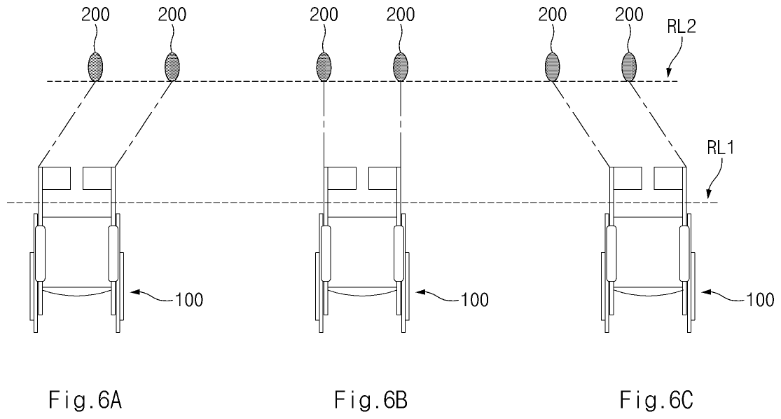

FIG. 6 is a view illustrating an example of a locational relationship of the mobility device and the walking assistance robot when they are in a parallel state, and illustrates a locational relationship that may be disposed in operation S410. That is, when the first detection distance d1 and the second detection distance d2 are adjusted to be the same, the mobility device 100 and the walking assistance robot 200 may be located in a state of FIG. 6.

The state may comprise a state in which the first center C1 of the mobility device 100 and the second center C2 of the walking assistance robot 200 are not aligned as in FIGS. 6A and 6C even though the mobility device 100 and the walking assistance robot 200 are parallel to each other. Accordingly, as in FIG. 6B, it is necessary to perform a control such that the first center C1 of the mobility device 100 and the second center C2 of the walking assistance robot 200 are aligned.

To achieve this, the controller 130 may horizontally move the mobility device 100 or the walking assistance robot 200, based on the image frame acquired by the camera 110.

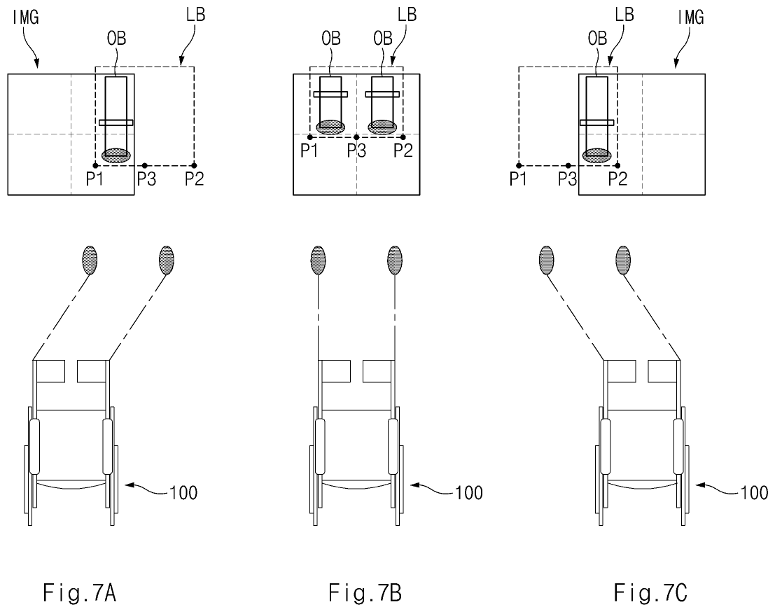

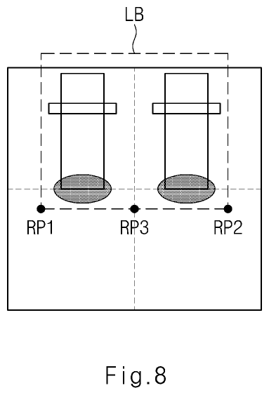

Referring to FIGS. 7 and 8, aligning the first center C1 of the mobility device 100 with the second center C2 of the walking assistance robot 200 based on the image frame will now be described.

FIGS. 7A to 7C show views illustrating an image frame acquired by the mobility device 100 when the mobility device 100 and the walking assistance robot are not aligned (FIGS. 7A to 7C) and when they are aligned (FIG. 7B).

The controller 130 may extract a target object from an image frame, (e.g., OB recognized in IMG in FIGS. 7A-C). The controller 130 may determine a movement control MC based on a determined location and/or a determined size of the target object. The movement control MC may be one or more of a movement control MC for moving the mobility device 100 as located relative to the walking assistance robot 200 in FIG. 7A or 7C to a location as illustrated in FIG. 7B. That is, the movement control MC may be a parameter that determines how much the mobility device 100 and/or the walking assistance robot 200 should be moved relative to the other.

Although an example in which the mobility device 100 is moved to arrange the mobility device 100 and the walking assistance robot 200 will be described in the following, the controller 130 may also, or alternatively, perform a control to cause movement of the walking assistance robot 200.

The movement control MC may be calculated based on Equation 1 as follows.

MC={para1×(coordinate deviation)}×{1/(para2×size of labeling box)} [Equation 1]

The coordinate deviation may refer to a deviation between coordinates of the image frame acquired by the camera 110 and a preset reference point. A method for calculating the coordinate deviation will be described in detail as follows.

The reference point may be one or more preset coordinates associated with a target image frame. As in FIG. 7B, the target image frame may be an image frame that is acquired in a state in which the first center C1 of the mobility device 100 and the second center C2 of the walking assistance robot 200 are aligned (e.g., the reference line RL1 is parallel to the reference line RL2 and a line between C1 and C2 is perpendicular to RL1 and RL2).

Referring to FIG. 8, the target image frame may comprise a reference point that may be set and/or defined in advance and/or may be set and/or defined with respect to a labeling box LB area of a recognized target object. The labeling box LB may be generated based on a result obtained by detecting the target object OB. For example, based on artificial intelligence learning (e.g., by the AI processor) and on one or more image frames acquired in the user switching configuration, and/or out of the user switching configuration, detection of a target object OB may be performed and a labeling box LB of the detected object OB may be generated.

The reference point may comprise first to third reference points RP1, RP2, and RP3. The first reference point RP1 may be a left lower apex of the labeling box LB, and the second reference point RP2 may be right lower apex of the labeling box LB. The third reference point RP3 may be a center reference point between the first reference point RP1 and the second reference point RP2. The third reference point RP3 may comprise a horizontal coordinate of a horizontal center of the image frame (e.g., in a case that the mobility device 100 and the walking assistance robot 200 are in a user switching configuration).

Object recognition may be performed on one or more images acquired by the camera 110. The object recognition may be performed using a model trained to recognize one or more portions of the walking assistance robot 200, such as the ground surface support part 230L and/or 230R, or a portion thereof. A labeling box LB may be generated for a recognized object OB. A first coordinate set P1 may be a left lower apex of the labeling box LB for the target object, and the second coordinate set P2 may be a right lower apex of the labeling box LB for the target object. The first coordinate P1 and/or second coordinate P2 may also, or alternatively, may be another point relative to the recognized object OB and/or the labeling box LB, such as a top left and/or top right apex, a point on the object, etc. The controller 130 may determine the third coordinate set P3 by calculating a center point between the first coordinate set P1 and the second coordinate set P2. The controller 130 may determine the first coordinate P1, the second coordinate P2, and/or the third coordinate P3 based on pixel coordinates of the image frame.

As in FIGS. 7A and 7C, only a partial area of the target object OB may be captured in the image frame. The coordinate system may be set to be larger than a size of the image frame (e.g., coordinates may be considered that are outside of the pixels included in the image frame.

As in FIG. 7B, when the entire area of the target object OB is captured in the image frame, the controller 130 may determine the first coordinate set P1 and the second coordinate set P2.

As in FIG. 7A, the second coordinate set P2 may not correspond to pixels of the image frame (e.g., may be outside of the image frame). The controller 130 may calculate the second coordinate set P2 in consideration of the first coordinate set P1 and the labeling box LB (e.g., a size, position and/or orientation of the labeling box LB).

Similarly, as in FIG. 7C, the first coordinate set P1 may not correspond to the pixels of the image frame. The controller 130 may calculate the first coordinate set P1 in consideration of the second coordinate set P2 and the labeling box LB.

The controller 130 may acquire the third coordinate set P3 by calculating the horizontal center of the first coordinate set P1 and the second coordinate set P2.

The controller 130 may calculate a coordinate deviation by calculating a deviation between the third coordinate set P3 and the third reference point RP3.

Furthermore, in Equation 1, a first parameter para1 may be one that is determined in advance to determine the movement control MC. The first parameter para1 may be determined based on a resolution of the image frame and a lens equation.

In Equation 1, a reason why the size of the labeling box is considered to calculate the movement control MC is as follows.

The deviation between the third coordinate set P3 and the third reference point RP3 may vary according to a distance between the mobility device 100 and the walking assistance robot 200, in addition to the horizontal deviation between the mobility device 100 and the walking assistance robot 200.

The size of the labeling box LB may vary according to the distance between the mobility device 100 and the walking assistance robot 200, and the deviation between the third coordinate set P3 and the third reference point RP3 may vary according to the size of the labeling box LB.

For example, even though the horizontal deviation is the same, the size of the labeling box LB may increase and the deviation between the third coordinate set P3 and the third reference point RP3 may increase as the distance between the mobility device 100 and the walking assistance robot 200 becomes shorter.

Accordingly, the controller 130 may determine the movement control MC in consideration of the size of the labeling box LB.

In Equation 1, a second parameter para2 may be one that is determined in advance to determine the movement control MC.

The second parameter para2 may be determined based on the resolution of the image frame and the lens equation.

In S430, the controller 130 may perform a control such that the mobility device 100 and the walking assistance robot 200 are spaced apart from each other by a reference distance. The reference distance may refer to a spacing distance between the mobility device 100 and the walking assistance robot 200 at the user switching configuration.

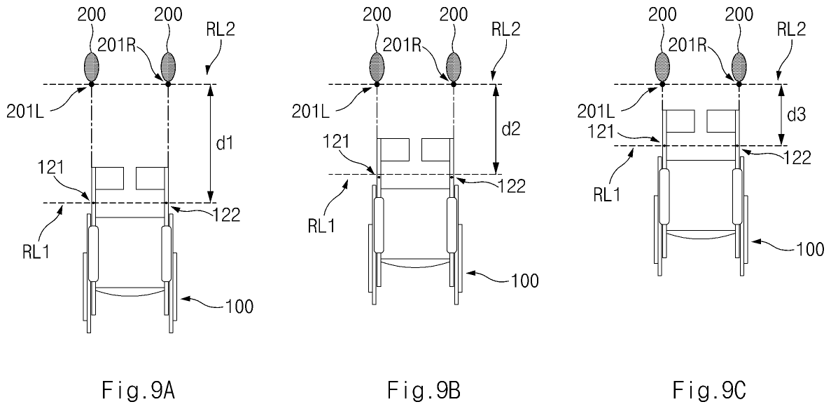

FIGS. 9A, 9B, and 9C show a view illustrating a method for adjusting the distance between the mobility device and the walking assistance robot.

Referring to FIGS. 9A, 9B, and 9C, through operations S410 to S420, the mobility device 100 and the walking assistance robot 200 may be located to face each other, in the parallel state as in FIGS. 9A, 9B, and 9C.

FIG. 9B illustrates a state, in which the mobility device 100 and the walking assistance robot 200 are spaced apart from each other by the reference distance Rd. FIG. 9A illustrates a state, in which the mobility device 100 and the walking assistance robot 200 are spaced apart from each other by a distance that is smaller than the reference distance Rd, and FIG. 9C illustrates a state, in which the mobility device 100 and the walking assistance robot 200 are spaced apart from each other by a distance that is larger than the reference distance Rd.

The controller 130 may be configured to control the distance detection sensor parts 120 and/or 201, e.g., so as to identify a spacing distance between the mobility device 100 and the walking assistance robot 200. The controller 130 may be configured to compare the spacing distance between the mobility device 100 and the walking assistance robot 200, which may have been acquired through the distance detection sensor parts 120 and 210 with the preset reference distance Rd.

The controller 130 may be configured to cause movement of the mobility device 100 toward the walking assistance robot 200, e.g., so as to adjust the distance d1 between the mobility device 100 and the walking assistance robot 200 to the reference distance Rd, e.g., at a location in FIG. 9A.

The controller 130 may be configured to cause movement of the mobility device 100 away from the walking assistance robot 200 so as to adjust the distance d3 between the mobility device 100 and the walking assistance robot 200 to the reference distance Rd, e.g., at a location in FIG. 9C

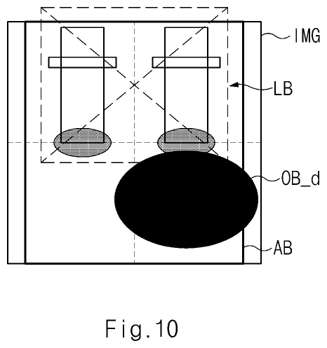

In a process of achieving the user switching configuration of the mobility device 100 and the walking assistance robot 200, an obstacle may be determined to be located between the mobility device 100 and the walking assistance robot 200, e.g., as in FIG. 10.

Referring to FIG. 10, the controller 130 may be configured to identify an obstacle OB_d, e.g., based on an image frame IMG acquired via the camera 110. The controller 130 may be configured to determine whether an obstacle is present in an effective range AB of the image frame IMG, based on applying an artificial intelligence learned model to the image frame IMG. The effective range AB may be a range that may overlap a straight movement range of the mobility device 100 or the walking assistance robot 200. Accordingly, the effective range AB may be set in consideration of a width of the mobility device 100 and a width of the walking assistance robot 200. The controller 130 may perform artificial intelligence learning to detect objects in the image frame, and may determine objects that may hinder movement of the mobility device 100 as obstacles.

Based on detection of an obstacle OB_d in the image frame IMG, the controller 130 may determine a location of the obstacle OB_d in the image frame IMG. The controller 130 may determine the location of the obstacle OB_d so as to identify at which location relative to the mobility device 100 in the horizontal direction the obstacle OB_d is located.

To achieve this, the controller 130 may identify whether the obstacle OB_d is located in a left area and/or a right area with respect to a center of the image frame IMG (e.g., in an x axis direction).

The controller 130 may determine the location of the obstacle OB_d by determining where relative to the center of the image frame IMG the labeling box LB of the obstacle OB_d is located. When the labeling box LB of the obstacle OB_d is present both to the left area and to the right relative to the center, the controller 130 may determine an area of the labeling box LB to the left of the center and an area of the labeling box LG to the right of the center, and may determine which area is largest. Also, or alternatively, a center point of the labeling box LB of the obstacle OB_d may be determined, a location of the center point may be used as the location of the obstacle OB_d.

The controller 130 may be configured to avoid the obstacle OB_d, e.g., by causing rotation of the walking assistance robot 200 and/or the mobility device 100.

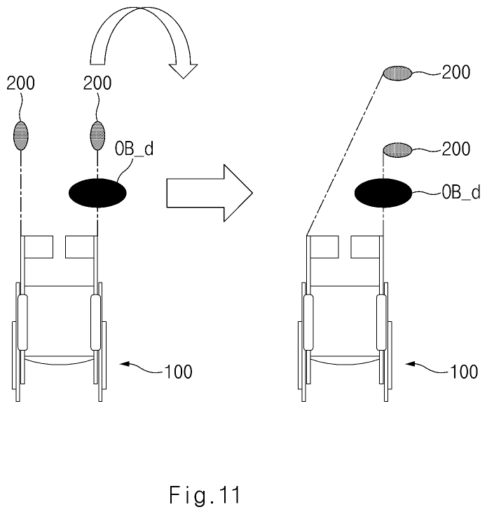

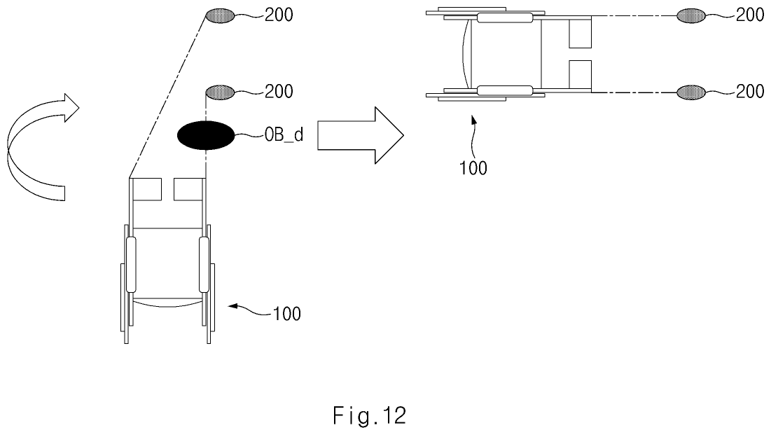

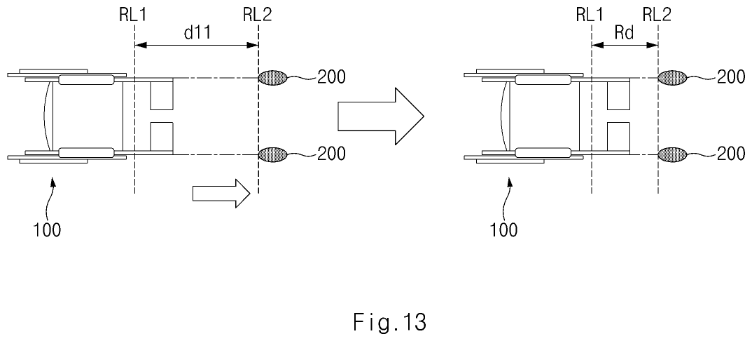

As in FIG. 11, when the obstacle OB_d is located to a right area of the mobility device 100, the controller 130 may rotate the walking assistance robot 200 in a counterclockwise direction. The center of rotation of the walking assistance robot 200 may be a center of the left ground surface support part 230L and the right ground surface support part 230R of the walking assistance robot 200.

As in FIG. 12, the controller 130 may rotate the mobility device 100 such that the mobility device 100 faces a rear side of the walking assistance robot 200. The controller 130 may rotate the mobility device 100 about the same center of rotation as that of the walking assistance robot 200. The controller 130 may rotate the mobility device 100 such that the mobility device 100 and the walking assistance robot 200 are parallel to each other (e.g., RL1 and RL2 are parallel).

As in FIG. 13, the controller 130 may rotate the mobility device 100 such that the mobility device 100 is spaced apart from the walking assistance robot 200 by the reference distance Rd.

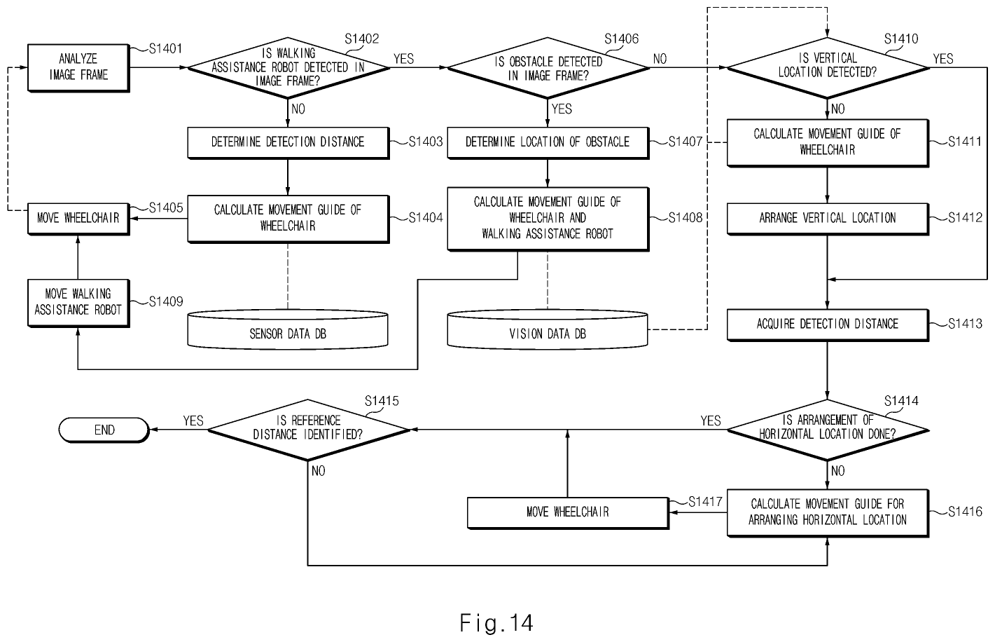

Referring to FIG. 14, a method for controlling a walking assistance system according to the present disclosure may comprise the following steps.

In S1401, the controller 130 may analyze an image frame acquired by the camera 110.

In S1402, the controller 130 may determine, by performing object recognition for an object consistent with the walking assistance robot 200, whether the walking assistance robot 200 is recognized in the image frame.

In S1403, if the walking assistance robot 200 is not detected in the image frame, the controller 130 may determine a detection distance between the mobility device 100 and the walking assistance robot 200 by controlling the distance detection sensor part.

In S1404, the controller 130 may calculate a movement guide based on the detection distance. The movement guide may be an instruction and/or other information adapted to control a movement of the mobility device 100 (e.g., an amount and direction of movement), and may comprise an instruction and/or other information indicating a vertical movement (for aligning centers of the mobility device 100 and the walking assistance robot 200) and a horizontal movement (for aligning front-facing directions of the mobility device 100 and the walking assistance robot) of the mobility device 100.

In S1405, the controller 130 may cause movement of the mobility device 100 (e.g., by sending the instruction and/or other information to one or more drives for causing motion of the mobility device 100, and/or by operating the one or more drives for causing motion of the mobility device 100).

After the mobility device 100 has been moved, and/or after the controller 130 has sent the instruction and/or other information, the controller 130 may return to S1401.

In S1406, the controller 130 may determine (e.g., by object recognition) whether an obstacle is detected in the image frame.

In S1407, if an obstacle is recognized in the image frame, the controller 130 may determine a location of the obstacle.

In S1408, based on the location of the obstacle, the controller 130 may calculate a movement guide of the mobility device 100 and/or a movement guide of the walking assistance robot 200.

In S1409, the controller 130 may cause movement of the walking assistance robot 200, based on the movement guide of the walking assistance robot 200.

Also, or alternatively, the controller may cause movement of the mobility device 100 based on the movement guide of the mobility device 100, based on a procedure of S1405.

In S1410, the controller 130 may determine whether the mobility device 100 and the walking assistance robot 200 are arranged vertically (e.g., have center points in alignment, as discussed above), based on the image frame (e.g., based on where an object recognized to be the walking assistance robot 200 is positioned in the image frame relative to an expected position).

In S1411, if it is determined that the mobility device 100 and the walking assistance robot 200 are not arranged vertically, the controller 130 may calculate an additional movement guide of the mobility device 100.

In S1412, the controller 130 may cause adjustment of the vertical location of the mobility device 100 by moving the mobility device 100 based on the movement guide calculated in S1411.

In S1413, after the vertical locations of the mobility device 100 and the walking assistance robot 200 are arranged (e.g., aligned), the controller 130 may determine the detection distances between the mobility device 100 and the walking assistance robot 200, as discussed previously.

In S1414, the controller 130 may determine whether the mobility device 100 and the walking assistance robot 200 are arranged horizontally (e.g., facing in parallel directions), based on the detection distances determined in S1413.

In S1415, the controller 130 may determine whether the mobility device 100 and the walking assistance robot 200 are spaced apart from each other by the reference distance, based on having determined that the mobility device 100 and the walking assistance robot 200 are horizontally arranged. If the mobility device 100 and the walking assistance robot 200 are spaced apart from each other by the reference distance, and/or a distance within an acceptable margin thereof, the user switching configuration may be determined to be achieved, and the method may end and/or continue from an earlier step (e.g., return to a beginning).

In S1416, if the mobility device 100 and the walking assistance robot 200 are determined to not be horizontally arranged, the controller 130 may cause movement of the mobility device 100 so as to cause the mobility device 100 and/or the walking assistance robot 200 to become arranged horizontally. When the mobility device 100 and the walking assistance robot 200 are arranged in the horizontal state, the controller 130 may start operation S1415.

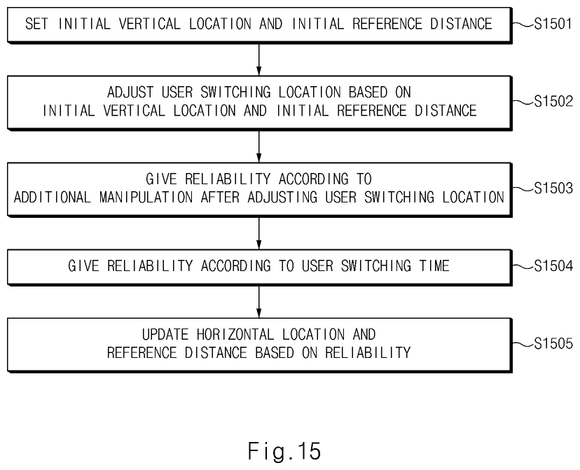

FIG. 15 shows a method for evaluating reliability according to an example of the present disclosure. The controller 130 may adjust the user switching configuration between the mobility device 100 and the walking assistance robot 200. The controller 130 may evaluate a reliability of the user switching configuration leading to successful user switching after adjusting the user switching configuration, and may update the user switching configuration based on the reliability.

In S1501, an initial vertical location and an initial reference distance may be set. The initial vertical location and the initial reference distance may be set by the user, may be pre-programmed, and/or may be learned by the AI processor (e.g., based on historical user switching data associated with a particular user and/or aggregated for other users, mobility devices, and/or walking assistance robots).

In S1502, the controller 130 may adjust the user switching configuration based on the initial vertical location and the reference distance.

The initial vertical location may be such that the first center C1 of the mobility device 100 and the second center C2 of the walking assistance robot 200 are located in a straight line that is perpendicular to the first reference line RL1. The controller 130 may consider (e.g., allow for) a margin of error in a process of adjusting the vertical location. For example, the controller 130 may determine that the vertical location is achieved when the first center C1 and the second center C2 are located within a specific margin range, even if a line between them is not perfectly perpendicular to reference line RL1. The margin may be a range. A limit of the range may be a distance over which an ability of a user to switch between the mobility device 100 and the walking assistance robot would not be significantly changed. For example, it may be determined that the vertical arrangement is accomplished when the first center C1 and the second center C2 are located in a range of 10 cm out of alignment with each other and/or when a line between the first center C1 and the second center C2 form an angle between 75°-105°, 80°-100°, 85°-95°, etc. with the reference line RL1.

The controller 130 may account for a margin of error (e.g., an allowable margin of error) in a process of adjusting the interval between the mobility device 100 and the walking assistance robot 200 to the initial reference distance. The margin may be set similarly to the margin discussed above.

In S1503, the controller 130 may determine a reliability according to an additional manipulation after the user switching configuration is adjusted.

In S1504, the controller 130 may give a reliability according to a user switching time.

The user switching configuration may vary according to the margin in a process of adjusting the horizontal location and the reference distance, and the controller 130 may set the user switching configuration into a more optimum state by giving the reliability according to the user switching configuration.

In operations S1503 and S1504, an example of giving the reliability will be described as follows.

To determine the reliability, the controller 130 may monitor whether the user additionally manipulates the mobility device 100 and/or the walking assistance robot 200 after the user switching is made. The additional manipulation may comprise one or more of a user input for adjusting horizontal movement and/or vertical movement of the mobility device 100 and/or horizontal movement and/or vertical movement of the walking assistance robot 200. The controller 130 may determine a lower reliability for a larger number of additional manipulations. For example, the controller 130 may determine a reliability of 3 points when no additional manipulation is made, a reliability of 2 points when one or two additional manipulations are made, and a reliability of 0 points when three or more additional manipulations are made.

To determine the reliability, the controller 130 may measure a time period over which a user performs the user switching. To measure the use switching time, one or more sensors may be included in one or more of the mobility device 100 and/or the walking assistance robot, wherein the one or more sensors may be capable of determining a movement of the user. For example, the sensor may be a pressure sensor (not illustrated) may in a seat of the mobility device 100, and/or a pressure sensor (not illustrated) at a portion of the walking assistance robot 200. The controller 130 may identify whether the user is seated on the mobility device 100 and/or wearing the walking assistance robot 200 based on the one or more sensor. The controller 130 may also, or alternatively, determine a time period for switching based on timing information indicating a time at which the user deviates from the mobility device 100 and a time at which the user begins to wear and/or be seated on the walking assistance robot 200, as the user switching time. Also, or alternatively, the controller 130 may determine a time period from a time at which the user deviates from the walking assistance robot 200, to a time at which the user mounts and/or is seated on the mobility device 100, as the use switching time. The controller 130 may give a reliability of a higher score as the use switching time is shorter. For example, the controller 130 may give a reliability of 3 points when the user switching time is 1 minute or less, and may give a reliability of 2 points when the use switching time is more than 1 minute and less than 3 minutes. Furthermore, the controller 130 may give a reliability of 0 point when the use switching time is more than 3 minutes.

Table 1 as follows is a table that represents a case, in which reliabilities are given in consideration of the additional manipulations and the use switching times.

TABLE 1

| | Number of additional | Use switching time | |
|---|---|---|---|
| | manipulations | (minutes) | Reliability |
| Case 1 | Two times | 2.4 | 4 |
| Case 2 | One time | 1 | 5 |
| Case 3 | Two times | 3.1 | 2 |
| Case 4 | X | 0.5 | 6 |
| Case 5 | X | 0.1 | 6 |

Referring to Table 1, the controller 130 may give a reliability of 2 points based on the number of additional manipulations in case 1, and may give a reliability of 2 points based on the use switching time. The controller 130 may give a reliability of 3 points based on the number of additional manipulations in case 2, and may give a reliability of 2 points based on the use switching time. In this way, the controller 130 may give the reliability based on the number of additional manipulations and the use switching time in each case.

In S1505, the vertical location and the reference distance may be updated based on the reliability.

The controller 130 may update the vertical location and the reference distance corresponding to a reliability of the highest point as the recent vertical location and the recent reference distance. Furthermore, the controller 130 may use the recent vertical location and the recent reference distance to perform an operation of adjusting the user switching configuration, which may be performed later.

According to the example of the present disclosure, because the mobility device and the walking assistance robot follow each other, uses of the mobility device and the walking assistance robot may be easily switched.

In addition, according to the example of the present disclosure, because the user switching configuration between the mobility device and the walking assistance robot is optimally set according to a user, the number of manipulations of the user and the use switching time may be reduced.

An aspect of the present disclosure provides a walking assistance system that may allow a user to easily switch uses of an mobility device and a walking assistance robot, and a method for controlling the same.

Another aspect of the present disclosure provides a walking assistance system that may reduce the number of manipulations of a user and a use switching time when uses of an mobility device and a walking assistance robot are switched, and a method for controlling the same.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a walking assistance system comprises an mobility device comprising wheels rotated by a first driving part, a walking assistance robot comprising one or more joint parts driven by a second driving part, and a controller that performs a control such that the mobility device and the walking assistance robot follow each other by driving at least any one of the first driving part or the second driving part, adjusts a relative horizontal location between the mobility device and the walking assistance robot, adjusts a relative vertical location between the mobility device and the walking assistance robot, and controls an interval between the mobility device and the walking assistance robot to a preset reference distance.

The controller may adjust locations of the mobility device and the walking assistance robot such that a first reference line that connects opposite ends of the mobility device and a second reference line that connects opposite ground surface support parts of the walking assistance robot are parallel to each other.

The controller may acquire a first detection distance between a first distance detection transmitter located on the first reference line and a first distance detection receiver located on the second reference line, acquire a second detection distance between a second distance detection transmitter spaced apart from the first distance detection transmitter by a reference width on the first reference line and a second distance detection receiver spaced apart from the first distance detection transmitter by the reference width on the second reference line, and adjust the horizontal location between the mobility device and the walking assistance robot by adjusting the locations of the mobility device and the walking assistance robot such that the first detection distance and the second detection distance are the same.

To adjust the relative vertical location between the mobility device and the walking assistance robot, the controller may adjust the locations of the mobility device and the walking assistance robot such that a first center corresponding to a center of the first distance detection transmitter and the first distance detection receiver on the first reference line and a second center corresponding to a center of the second distance detection transmitter and the second distance detection receiver on the second reference line are located on one line that is perpendicular to the first reference line.

To adjust the relative vertical location between the mobility device and the walking assistance robot, the controller may acquire a front image through a camera mounted on the mobility device, detect an object of the walking assistance robot in the image, and adjust the locations of the mobility device and the walking assistance robot such that a horizontal center of the object and a center of the mobility device coincide with each other.

To adjust the locations of the mobility device and the walking assistance robot such that the horizontal center of the object and the center of the mobility device coincide with each other, the controller may acquire the horizontal center of the object, and adjust the locations of the mobility device and the walking assistance robot such that the horizontal center of the object coincides with a preset center of a target object for the walking assistance robot.

To adjust the relative vertical location between the mobility device and the walking assistance robot, the controller may acquire a labeling box of the object, and adjust a movement degree of the mobility device or the walking assistance robot, based on a size of the labeling box.

To adjust the relative vertical location between the mobility device and the walking assistance robot, the controller may control movement of the mobility device and the walking assistance robot such that an obstacle is avoided, based on that an object corresponding to the obstacle is detected in the image.

The controller may, after the interval between the mobility device and the walking assistance robot is controlled to a present reference distance, measure a use switching time of the mobility device and the walking assistance robot, by a user, calculate a reliability according to the use switching time, and update at least any one of the horizontal location or the vertical location, based on the reliability.

The controller may monitor whether the user inputs an additional manipulation for a use switching, and adjust the reliability based on the additional manipulation.

According to an aspect of the present disclosure, a method for controlling a walking assistance system comprises adjusting a relative horizontal location between an mobility device and a walking assistance robot by controlling at least any one of the mobility device and the walking assistance robot, adjusting a relative vertical location between the mobility device and the walking assistance robot by controlling at least any one of the mobility device and the walking assistance robot, and controlling an interval between the mobility device and the walking assistance robot to a preset reference distance by controlling at least any one of the mobility device and the walking assistance robot.

The adjusting of the relative horizontal location between the mobility device and the walking assistance robot may comprise adjusting locations of the mobility device and the walking assistance robot such that a first reference line that connects opposite ends of the mobility device and a second reference line that connects opposite ground surface support parts of the walking assistance robot are parallel to each other.

The adjusting of the relative horizontal location between the mobility device and the walking assistance robot may comprise acquiring a first detection distance between a first distance detection transmitter located on the first reference line and a first distance detection receiver located on the second reference line, acquiring a second detection distance between a second distance detection transmitter spaced apart from the first distance detection transmitter by a reference width on the first reference line and a second distance detection receiver spaced apart from the first distance detection transmitter by the reference width on the second reference line, and adjusting a relative horizontal location between the mobility device and the walking assistance robot by adjusting the locations of the mobility device and the walking assistance robot such that the first detection distance and the second detection distance are the same.

The adjusting of the relative vertical location between the mobility device and the walking assistance robot may comprise adjusting the locations of the mobility device and the walking assistance robot such that a first center corresponding to a center of the first distance detection transmitter and the first distance detection receiver on the first reference line and a second center corresponding to a center of the second distance detection transmitter and the second distance detection receiver on the second reference line are located on one line that is perpendicular to the first reference line.

The adjusting of the relative vertical location between the mobility device and the walking assistance robot may comprise acquiring a front image through a camera mounted on the mobility device, detecting an object of the walking assistance robot in the image, and adjusting the locations of the mobility device and the walking assistance robot such that a horizontal center of the object and a center of the mobility device coincide with each other.

The adjusting of the locations of the mobility device and the walking assistance robot such that the horizontal center of the object and the center of the mobility device coincide with each other may comprise acquiring the horizontal center of the object, and adjusting the locations of the mobility device and the walking assistance robot such that the horizontal center of the object coincides with a preset center of a target object for the walking assistance robot.

The adjusting of the relative vertical location between the mobility device and the walking assistance robot may comprise acquiring a labeling box of the object, and adjusting a movement degree of the mobility device or the walking assistance robot, based on a size of the labeling box.

The adjusting of the relative vertical location between the mobility device and the walking assistance robot may comprise controlling movement of the mobility device and the walking assistance robot such that an obstacle is avoided, based on that an object corresponding to the obstacle is detected in the image.

The method may further comprise, after the interval between the mobility device and the walking assistance robot is controlled to present reference distance, measuring a use switching time of the mobility device and the walking assistance robot, by a user, calculating a reliability according to the use switching time, and updating at least any one of the horizontal location or the vertical location, based on the reliability.

The calculating of the reliability may comprise monitoring whether the user inputs an additional manipulation for a use switching, and adjusting the reliability based on the additional manipulation.

In addition, the present disclosure may provide various effects that are directly or indirectly recognized.

The above description is a simple exemplification of the technical spirits of the present disclosure, and the present disclosure may be variously corrected and modified by those skilled in the art to which the present disclosure pertains without departing from the essential features of the present disclosure.

The examples disclosed in the present disclosure do not limit the technical spirit of the present disclosure, but are provided for illustrative purposes. Accordingly, the technical scope of the present disclosure should be construed by the following claims, and all the technical spirits within the equivalent ranges fall within the scope of the present disclosure.

What is claimed is:

1. A control device comprising:
one or more processors; and
memory storing instructions that, when executed by the one or more processors, cause the control device to:
cause, by controlling at least one of a first drive of a mobility device or a second drive of a mobility assistance robot, the mobility device and the mobility assistance robot to be in a predefined relative orientation with each other;
cause, by controlling at least one of the first drive or the second drive, the mobility device and the mobility assistance robot to be in a predefined spatial alignment with each other; and
cause, by controlling at least one of the first drive or the second drive, a distance between the mobility device and the mobility assistance robot to be a preset reference distance.

2. The control device of claim 1, wherein the instructions, when executed by the one or more processors, cause the control device to:
cause the mobility device and the mobility assistance robot to be in the predefined relative orientation with each other by causing adjustment of at least one of a location of the mobility device or a location of the mobility assistance robot, wherein the causing the adjustment causes a first reference line that connects opposite ends of the mobility device and a second reference line that connects opposite ground surface support parts of the mobility assistance robot to be parallel to each other.

3. The control device of claim 2, wherein the instructions, when executed by the one or more processors, cause the control device to:
cause adjustment of the at least one of the locations by:
monitoring a first detection distance between a first distance detection transmitter located on the first reference line and a first distance detection receiver located on the second reference line;
monitoring a second detection distance between a second distance detection transmitter, spaced apart from the first distance detection transmitter by a reference width on the first reference line, and a second distance detection receiver, spaced apart from the first distance detection transmitter by the reference width on the second reference line; and
causing adjustment of the at least one of the locations such that the first detection distance is the same as the second detection distance.

4. The control device of claim 1, wherein the instructions, when executed by the one or more processors, cause the control device to:
cause the mobility device and the mobility assistance robot to be in the predefined spatial alignment with each other by causing adjustment of at least one of a location of the mobility device or a location of the mobility assistance robot such that a line defined by a first center reference point, between opposite ends of the mobility device, and a second center reference point, between opposite ground surface support parts of the mobility assistance robot, is perpendicular to a reference line defined by opposite ends of the mobility device.

5. The control device of claim 4, wherein the instructions, when executed by the one or more processors, cause the control device to:
receive an image via a camera associated with the mobility device;
perform object recognition on the image; and
based on recognizing the mobility assistance robot in the image at a recognized position and comparing the recognized mobility assistance robot to a predefined position in the image, cause adjustment of at least one of a location of the mobility device or a location of the mobility assistance robot such that a horizontal center of the mobility assistance robot and a horizontal center of the mobility device coincide with each other.

6. The control device of claim 5, wherein the instructions, when executed by the one or more processors, cause the control device to:
cause adjustment of the at least one of the locations by:
determining a horizontal center of the recognized mobility assistance robot in the image; and
adjusting the at least one of the locations such that the horizontal center of the recognized mobility assistance robot in the image coincides with a preset center position indicated by the predefined position in the image.

7. The control device of claim 5, wherein the instructions, when executed by the one or more processors, cause the control device to:
cause adjustment of the at least one of the locations by:
determining information indicating a labeling box of the recognized mobility assistance robot; and
causing adjustment of the at least one of the locations based on a size of the labeling box.

8. The control device of claim 5, wherein the instructions, when executed by the one or more processors, cause the control device to:
cause adjustment of the at least one of the locations by controlling movement of at least one of the mobility device or the mobility assistance robot to avoid an obstacle corresponding to an obstacle object recognized in the image.

9. The control device of claim 1, wherein the instructions, when executed by the one or more processors, cause the control device to:
receive information indicating that a user switched between using the mobility device and the mobility assistance robot;
determine a user switching time indicated by the information;
calculate a reliability metric based on the user switching time; and
update, based on the calculated reliability metric, at least one of the predefined relative orientation, the predefined spatial alignment, or the preset reference difference.

10. The control device of claim 9, wherein the instructions, when executed by the one or more processors, cause the control device to calculate the reliability metric further based on an indication of a user manipulation of one or more of the mobility device or the mobility assistance robot.

11. A method comprising:
causing, by controlling at least one of a first drive of a mobility device or a second drive of a mobility assistance robot, the mobility device and the mobility assistance robot to be in a predefined relative orientation with each other;
causing, by controlling at least one of the first drive or the second drive, the mobility device and the mobility assistance robot to be in a predefined spatial alignment with each other; and
causing, by controlling at least one of the first drive or the second drive, a distance between the mobility device and the mobility assistance robot to be a preset reference distance.

12. The method of claim 11, wherein the causing the mobility device and the mobility assistance robot to be in the predefined relative orientation with each other comprises:
causing adjustment of at least one of a location of the mobility device or a location of the mobility assistance robot, wherein the causing the adjustment causes a first reference line that connects opposite ends of the mobility device and a second reference line that connects opposite ground surface support parts of the mobility assistance robot to be parallel to each other.

13. The method of claim 12, wherein the causing adjustment of the at least one of the locations comprises:
monitoring a first detection distance between a first distance detection transmitter located on the first reference line and a first distance detection receiver located on the second reference line;
monitoring a second detection distance between a second distance detection transmitter, spaced apart from the first distance detection transmitter by a reference width on the first reference line, and a second distance detection receiver, spaced apart from the first distance detection transmitter by the reference width on the second reference line; and
causing adjustment of the at least one of the locations such that the first detection distance is the same as the second detection distance.

14. The method of claim 11, wherein the causing the mobility device and the mobility assistance robot to be in the predefined spatial alignment with each other comprises:
causing adjustment of at least one of a location of the mobility device or a location of the mobility assistance robot such that a line defined by a first center reference point, between opposite ends of the mobility device, and a second center reference point, between opposite ground surface support parts of the mobility assistance robot, is perpendicular to a reference line defined by opposite ends of the mobility device.

15. The method of claim 14, further comprising:
receiving an image via a camera associated with the mobility device;
performing object recognition on the image; and
based on recognizing the mobility assistance robot in the image at a recognized position and comparing the recognized mobility assistance robot to a predefined position in the image, causing adjustment of at least one of a location of the mobility device or a location of the mobility assistance robot such that a horizontal center of the mobility assistance robot and a horizontal center of the mobility device coincide with each other.

16. The method of claim 15, wherein the causing adjustment of the at least one of the locations comprises:
determining a horizontal center of the recognized mobility assistance robot in the image; and
adjusting the at least one of the locations such that the horizontal center of the recognized mobility assistance robot in the image coincides with a preset center position indicated by the predefined position in the image.

17. The method of claim 15, wherein the causing adjustment of the at least one of the locations comprises:
determining information indicating a labeling box of the recognized mobility assistance robot; and
causing adjustment of the at least one of the locations based on a size of the labeling box.

18. The method of claim 15, wherein the causing adjustment of the at least one of the locations comprises:
controlling movement of the mobility device or the mobility assistance robot to avoid an obstacle corresponding to an obstacle object recognized in the image.

19. The method of claim 11, further comprising:
receiving information indicating that a user switched between using the mobility device and the mobility assistance robot;
determining a user switching time indicated by the information;
calculating a reliability metric based on the user switching time; and
updating, based on the reliability metric, at least one of the predefined relative orientation, the predefined spatial alignment, or the preset reference difference.

20. The method of claim 19, wherein the calculating of the reliability metric is further based on an indication of a user manipulation of one or more of the mobility device or the mobility assistance robot.
